(19) United States
(12) Patent Application Publication
(10) Pub. No.: US 2024/0372909 A1
(43) Pub. Date: Nov. 7, 2024

(54) PRIORITIZATION OF DATA STREAMS BETWEEN A SOURCE OF AUDIO/VIDEO CONTENT AND TELECOMMUNICATION CLIENTS

(71) Applicant: Orange, Issy-Les-Moulineaux (FR)

(72) Inventors: Hervé MARCHAND, Chatillon Cedex (FR); Mathieu RIVOALEN, Chatillon Cedex (FR)

(21) Appl. No.: 18/654,492

(22) Filed: May 3, 2024

(30) Foreign Application Priority Data
May 4, 2023 (FR) 2304476

(51) Int. Cl. H04L 65/80; H04L 41/5025; H04L 65/611

(52) U.S. Cl. CPC H04L 65/80; H04L 41/5025; H04L 65/611

(57) ABSTRACT

A method for transmitting a set of data streams through a telecommunications network, the data streams being respectively transmitted to sets of clients, the method including the assignment of a maximum quality allocated to a data stream as a function of the number of clients in the set of clients to which the data stream is transmitted.

### CROSS-REFERENCE TO RELATED APPLICATIONS

This application claims foreign priority to French Application No. 2304476, entitled “PRIORITISATION OF DATA STREAMS BETWEEN A SOURCE OF AUDIO/VIDEO CONTENT AND TELECOMMUNICATION CLIENTS” and filed May 4, 2023, the content of which is incorporated by reference in its entirety.

### BACKGROUND

### Field

The present development relates to the field of the transmission of data streams over a telecommunications network, in particular including digital multimedia content, namely digital audio and/or video content, also called audiovisual content.

### Description of the Related Technology

The development relates, more particularly, to the management of this transmission, for example in the event of congestion of the telecommunications network.

In certain situations, a same piece of content may have to be transmitted to a plurality of receivers. This is the case, for example for video on demand, but especially for live streaming. Whether it concerns audio (radio broadcasting) or video (television broadcasting) content, different users register a viewing terminal (television, computer, mobile terminal, etc.) in order to receive an audiovisual program.

Typically, in this situation, the transmission is carried out in multicast mode.

In such a mode, the terminals interested in receiving a content must join a group of terminals having requested a subscription to the same piece of content using, for example, an IGMP protocol (Internet Group Management Protocol) if it involves IPv4 terminals, or the MLD protocol (Multicast Listener Discovery) if it involves IPv6 terminals. More specifically, a terminal must be a member of a group in order to receive a given multicast stream.

It is the IP network, in particular nodes formed by routers, which is then responsible for optimally replicating the traffic as close as possible to the terminals. These nodes form a distribution tree.

The m-ABR mode (multicast Adaptive Bit Rate) uses an adaptive transmission technique according to which more or less voluminous content segments are selected, depending on the current bandwidth on the telecommunications network. These transmissions are carried out by a multicast transport.

This multicast ABR mode has the advantage of reducing the consumption of network capacity, since a single transmission can route the content as close as possible to the receiving terminals, according to the distribution tree.

When the communication network is subject to congestion, the bandwidth of the m-ABR stream can be reduced, by taking advantage of the adaptive nature of this mode of transmission.

If a plurality of m-ABR data streams are concerned, these can see their bandwidth reduced arbitrarily and, in particular, independently of the impact that this reduction may have on the general experience for the set of receiving terminals.

There is therefore a need to improve the current proposals of the prior art.

### SUMMARY

The development aims to improve the general experience of the set of receiving terminals, in particular in the event of congestion of the telecommunications network.

According to the development, this improvement is achieved by taking into account the number of receivers associated with each stream.

For this purpose, according to a first aspect, the present development can be implemented by a method for transmitting a set of data streams (F) through a telecommunications network, the data streams being respectively transmitted to sets of clients, said method including the assignment of a maximum quality allocated to a data stream, as a function of the number of clients in said set of clients to which said data stream is transmitted.

This assignment can be triggered during the detection of a congestion situation of said telecommunications network. It can also be triggered when a future congestion situation is predicted (for example statistically or by extrapolation of a trend), or during a substantial drop in the bandwidth of the network, etc.

Thus, if possible, in particular, to modulate the reductions in quality (and thus in bandwidth) of the data streams as a function of the number of users impacted, in order to optimise overall satisfaction.

According to preferred embodiments, the development comprises one or more of the following features which can be used separately or partially combined with one another or fully combined with one another:
when said set of clients comprises at least two clients, said stream is transmitted in multicast mode, and when said set of clients comprises only a single client, said stream is transmitted in unicast mode. This makes it possible, in particular, to reduce the consumption of network capacity of the telecommunications network.
said assignment of a maximum quality comprises, for a multicast stream, configuring a source of said data streams for transmitting the data best corresponding to said maximum quality allocated to said data stream. Thus, the transmission of the streams is optimised from their point of emission.
said maximum quality is higher when said number of clients is higher
said assignment of a maximum quality comprises, for a unicast stream, a modification of the service plan for said data stream in order that it only includes qualities less than or equal to said maximum quality allocated to said data stream. This makes it possible, in particular, to minimise the impact for the overall architecture of the system and to be compatible with existing devices.
the maximum quality allocated to the data streams transmitted to the sets with the highest number of clients is not impacted. Thus, the stream the most requested by the end clients is not penalised, and the optimisation concerns the least requested streams.

The method includes an assignment of a new maximum quality allocated to a data stream, after a delay greater than a determined time threshold. This makes it possible to progressively increase the power of the correction mechanisms of the network, in order to initially limit the impacts. This new maximum quality can, for example, be assigned when said network is still in a congestion situation after this time threshold.

Another aspect of the development concerns a supervision device comprising a processor configured to perform:
assigning of a maximum quality allocated to a data stream, as a function of the number of clients in a set of clients to which said data stream is transmitted through said telecommunications network.

According to an embodiment, the supervision device is further intended to detect a congestion situation of a telecommunications network, and to trigger the assignment in the event of congestion.

As seen above, the supervision device can also trigger the assignment when a future congestion situation is predicted (for example statistically, or by extrapolation of a trend), or during a substantial drop in the bandwidth of the network, etc.

Another aspect of the development concerns a system comprising a source of said data streams and a supervision device as previously described.

Another aspect of the development concerns a system as previously described, wherein said source includes an interface intended to interoperate with said supervision device.

Another aspect of the development concerns a computer program able to be implemented on a supervision device, the program comprising code instructions which, when it is executed by a processor, performs the method steps as previously described.

Another aspect of the development concerns a data medium on which at least one series of program code instructions for executing a method as previously described is stored.

Other features and advantages of the development will become apparent on reading the following description of a preferred embodiment of the development, given by way of example and with reference to the attached drawings.

### BRIEF DESCRIPTION OF THE DRAWINGS

The attached drawings illustrate the development:

FIG. 1 illustrates a telecommunications network enabling implementation of a method according to the embodiments of the development;

FIG. 2 schematically shows details of the design, according to an implementation of the development.

### DETAILED DESCRIPTION OF CERTAIN ILLUSTRATIVE EMBODIMENTS

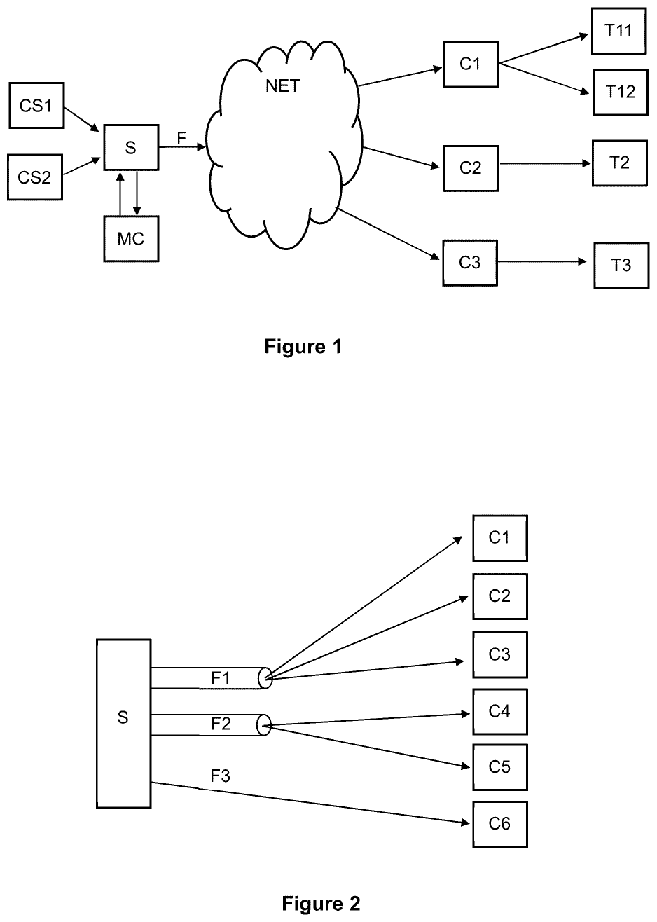

FIG. 1 illustrates a telecommunications network enabling data streams to be routed between one or more content servers, to a set of terminals.

These terminals can be terminals for reading multimedia streams of various types, such as, in particular, a mobile terminal, a smart television, a computer, etc.

The mobile terminal can typically be a smart phone or a digital tablet, suitable for receiving multimedia streams and for producing them on an interface of the terminal or connected to said terminal.

The television TV can be natively connected or be connected via the intermediary of an associated device such as an HDMI dongle connected to the television.

An example of an external device communicating with a television TV is Chromecast. Chromecast is a real-time multimedia streaming device (multimedia gateway) developed and marketed by Google. The device connects to the HDMI port of a television and communicates, by Wi-Fi connection, with another device connected to the Internet (computer, smartphone, tablet . . . ), in order to display, on the television, the multimedia content received from an application compatible with Google Cast technology, from the Google Chrome browser present on a computer, or from certain Android devices.

In the latter case, the terminal reading multimedia streams or content, can be this associated device.

The data streams can be multimedia streams. These typically comprise video or audio/video streams (or content). It can also involve audio streams (music, radio programs, etc.), or interactive content (including games). It can also involve content on demand or “live” content. This mode of transmission can be an IPTV transmission mode (“Internet Protocol Television”), but other transmission modes are obviously possible.

In the example of FIG. 1, two content servers CS1, CS2 can supply a data stream F (for example of video content) to terminals T11, T12, T2, T3, through the telecommunications network NET, to which they are connected in a manner known per se. This telecommunications network can comprise a plurality of interconnected networks, in particular a local network, an access network and an extended network “Internet”.

The local network can be a network installed in a user's home enabling him to connect various terminals to an access point which forms a gateway to an access network to the extended network. Such a local network can comprise various technologies, for example Wi-Fi, Ethernet™, etc.

In this example, it is assumed that the terminals are located in a limited geographical region. The transmission of the data stream F can be carried out in multicast mode. This data stream F can be, for example, an m-ABR (“multicast-Adaptive Bit Rate”) stream.

In general, multicast ABR (Adaptive Bitrate) is a streaming technology for video content which enables the transmission of content in a single stream to a plurality of users simultaneously. (Unlike unicast live streaming, which sends a distinct data stream to each user).

Multicast ABR uses a distribution method which reduces the load on the network of the operator and enables large-scale content streaming. It functions by dividing the content into a plurality of streams with different bitrates, and automatically adapting the streaming rate as a function of the bandwidth capacities of the connected users. This enables each user to receive the content with the best quality possible according to their network environment.

The data stream F can transit between a multicast server S and clients C1, C2, C3. In particular, it can involve an m-ABR server and m-ABR clients respectively.

The m-ABR server is responsible for transmission of the video content to the clients connected via a multicast network. It divides the content into a plurality of streams of different quality (or rates), each being adapted to the bandwidth capacities of the network and of the users. The connected clients can then choose the stream of appropriate quality according to their network environment (local network enabling the connection between the client and the terminal), or the capacity of this terminal.

The m-ABR client, in turn, is responsible for the reception of the video content, or more generally of the data stream. It connects to the m-ABR server via the multicast network and chooses the stream of appropriate quality from those available by subscribing to it. The client also uses adaptation algorithms to ensure that the streaming rate remains optimum as a function of changes in bandwidth.

As described for ABR (“Adaptive Bitrate”), the video content is streamed in a plurality of streams of different quality (or rates) in order to adapt to the bandwidth capacities of the network and of the users. The qualities available depend on the resolution, the transfer rate and the video codec used.

The available qualities in ABR can vary according to the video streaming platform used but, in general and currently, the current qualities comprise:
Very low quality: often suitable for users with very slow or unstable Internet connections, this quality can have a resolution of 240p and a transfer rate of 200 kbps.
Low quality: this quality is suitable for more stable but still relatively slow Internet connections, with a resolution of 360p and a transfer rate of 400-700 kbps.
Standard quality: this quality is suitable for the majority of Internet connections, with a resolution of 480p or 720p and a transfer rate of 800 kbps to 2 Mbps.
High quality: this quality is suitable for fast and reliable Internet connections, with a resolution of 1080p and a transfer rate of 2-5 Mbps.
Very high quality: this quality is suitable for very fast Internet connection, with a resolution of 4K and a transfer rate of more than 10 Mbps.

It is important to note that the available qualities can vary as a function of the bandwidth capacities of the user and of the network, as well as the quality and complexity of the streamed video content.

The server S encapsulates the data in multicast data packets and transmits these packets in a distribution tree where they are routed to the clients C1, C2, C3.

The clients decapsulate the multicast packets and transmit them to the terminals which are attached to them, in unicast mode. Client C1 transmits the data stream to terminals T11 and T12, client C2 transmits the data stream to terminal T2 and client C3 transmits the data stream to terminal T3.

In such a configuration, the access device can first carry out the processes necessary to convert the PDU (“Protocol Data Unit”) from multicast mode to unicast mode.

The terminals can be attached to the clients, or else embed such a client.

In an embodiment, clients C1, C2, C3 are embedded in Internet access devices, of the Internet box or multi-service box type. An example of such a device is the Livebox™ from Orange. These devices make it possible to connect the various terminals of a home or of a business to the Internet network.

The clients can also be embedded within the terminals themselves.

FIG. 2 illustrates an example of transmission of a plurality of data streams, F1, F2, F3 from a server S to clients C1, C2, C3, C4, C5, C6. Each of these clients can be attached to terminals (not shown) enabling data streams to be provided to the end user, as previously described.

Each data stream is associated with a set of clients. Thus, stream F1 is associated with clients C1, C2, C3; stream F2 is associated with clients C4, C5, and stream F3 is associated with client C6.

Each stream is transmitted to the associated set of clients. This transmission is carried out in multicast mode if the associated set comprises at least 2 clients.

Thus, streams F1 and F2 are transmitted in multicast mode, whereas data stream F3 is transmitted in unicast mode.

The method can provide monitoring of the load of the telecommunications network, or, more precisely of the distribution tree associated with the transmission of the data streams from the server S. A supervision device, MC, can be used to monitor the network load. It is thus possible to determine, in quasi real-time, a congestion situation of the network, but other modes for detecting this situation can also be possible. Similarly, the supervision device can also predict a future congestion situation (for example statistically or by extrapolation of a trend), or even a substantial drop in the bandwidth of the network, etc.

The determination of a congestion situation can be carried out by comparing a load measurement with a threshold, or with a plurality of thresholds.

A threshold can define a congestion situation when the measured load is greater than it.

A plurality of thresholds can be defined, in order to determine a plurality of congestion levels.

The supervision device MC can be responsible, on the one hand, for measuring the load of the telecommunications network NET in order to detect a congestion situation, and also for assigning a maximum quality allocated to a data stream.

This supervision device MC can be deployed close to the multicast source S.

More specifically, since the streaming of a content in multicast follows a distribution tree, the various data streams originating from a same source share more of the same bandwidth close to the root of the distribution tree. Further, the load measurements close to this root are more relevant and better able to reveal the actual state of the network load.

In a particular case, the supervision device MC can be integrated within the multicast source S. In a more general case, the two devices can be distinctive devices but are able to cooperate.

According to the proposed method, when a congestion situation of the telecommunications network is detected, a maximum quality allocated to a data stream as a function of the number of clients in the associated set is assigned.

It should be noted that the assignment is made for a data stream, and not per segment or per packet. The maximum quality is assigned for a stream comprising a set of data packets.

It should further be noted that this maximum quality is that at which the clients can, at most, require the content. This assigned quality is guaranteed to the clients, as opposed to transmission modes of the “best effort” type, such as the DiffServ mechanism described in the RFC 2474 of the IETF.

The triggering of the assignment of a maximum quality can however be triggered in other situations, as was seen above.

It is thus possible to assign a higher maximum quality to a data stream associated with a set of higher cardinality. In other words, the maximum quality is higher when the the number of clients is higher

Thus, if a stream F_{A} is associated with a set of clients of cardinality n_{A}, and if a stream F_{B} is associated with a set of cardinality n_{B}, maximum qualities Q_{A} and Q_{B}, can be respectively assigned to the stream F_{A} and F_{B}, such that n_{A}>n_{B}→Q_{A}>Q_{B}.

In the example of FIG. 2, the stream F₁ is associated with a set of 3 clients, the stream F2 is associated with a set of 2 clients and the stream F3 is associated with a set of a single client (and is therefore a unicast stream).

A maximum quality, Q1, Q2, Q3 respectively, can therefore be assigned to these streams such that Q1>Q2>Q3.

The maximum quality allocated to a data stream is the maximum quality to which terminals connected to the corresponding client can have access. The terminals can automatically choose (and/or leave the user to to choose manually) a quality from the qualities available for the received stream.

These qualities correspond, in particular, to a transfer rate of the data streams which is, in particular, a function, in the case of a video stream, of a number of images per second and an image size.

Thus the overall satisfaction of the users is optimised as a function of the resources available on the telecommunications network. In particular, the method makes it possible to satisfy the largest number by offering the highest maximum quality to the data streams transmitted to a larger number of clients, possibly by sacrificing the maximum quality of streams transmitted to a smaller number of clients.

More specifically, if it is considered that a congestion situation of this telecommunications network requires the degradation of the maximum quality of at least certain transmitted data streams, the described method makes it possible to favour the data streams transmitted to a larger number of clients, to the detriment of those transmitted to a smaller number.

As a result of reducing the available quality of the streams transmitted to fewer clients, fewer users are technically impacted by the degradation in quality and therefore potentially unsatisfied.

Thus degrading the quality in an undifferentiated or arbitrary manner as in the prior art is avoided, where, for example, the maximum quality of all the data streams is reduced in the same way. In other words, in the event of congestion of the network, competition is avoided between a unicast stream and a multicast stream (in m-ABR, for example), which delivers a larger number of users.

According to an embodiment, when a congestion situation is detected, the stream or streams associated with the largest sets of clients are not impacted, and are therefore assigned the highest maximum quality. Conversely, the data streams associated with sets of clients of lower cardinality are assigned to more reduced maximum qualities.

For example, according to an embodiment, thresholds can be defined on the number of clients in the sets of clients.

For example, in the event of congestion, the maximum quality allocated to the stream associated with sets of clients below the threshold is reduced, but not that allocated to the stream associated with sets of clients above this threshold.

According to an embodiment, in the event of a congestion situation, the quality of the video streams is favoured in the following order:
A “Priority 1” profile is assigned to the multicast stream delivering to more than N clients (N=20 for example).
A “Priority 2” profile is assigned to the multicast stream delivering to less than N clients (but more than 2 clients)
A “priority 3” profile is assigned to the unicast stream.

In this example, two thresholds are therefore defined, N and 2 (in other words the unicast/multicast decision point).

For these 3 profiles, rules can be defined for assigning the allocated maximum quality. For example, the maximum quality allocated to the “Priority 1” profile is not modified, the maximum quality allocated to the “Priority 2” profile is slightly reduced, and the maximum quality allocated to the “Priority 3” profile is more substantially reduced.

The assigning of an allocated maximum quality may involve deleting the highest available qualities. For example, in the case of a “Priority 2” protocol, the highest quality available is deleted; in the case of the “Priority 3” profile, the two highest qualities available are deleted.

For the data streams transmitted in unicast, (see the example of stream F3 in FIG. 2), the assignment of a maximum quality comprises, for a unicast stream, modifying the service plan for this data stream in order that it only includes qualities less than or equal to the maximum quality allocated to the data stream F3.

From then on, client C6 will react by subscribing to a quality available in the service plan in order to continue to receive the content corresponding to data stream F3.

Assigning maximum quality may comprise, for a multicast stream, F1, F2, configuring the source S of the data stream for transmitting data best corresponding to this allocated maximum quality.

The supervision device, MC, can be provided to configure the source S by specifying the resolutions (or qualities) to be transmitted in the m-ABR stream. The source S and the supervision device can, for example, interoperate by means of an API interface (Application Programming Interface) presented by the source S.

According to an embodiment, a new allocated maximum quality can be assigned to a data stream when the network is still in a congestion situation after a delay greater than a determined time threshold. The time threshold can be fixed, for example, at several minutes.

Thus, a reduction of a quality on a stream in order to respond to congestion of the network may not be sufficient and, after a certain time, if the network is still congested, new measures can be taken. In particular, a new limitation on the qualities available for a data stream can be decided.

It should be noted that, as specified above, the service plan corresponds to the qualities available for the data stream. Here, it is proposed to vary the available qualities to which the clients can subscribe, depending on the load and the number of clients having subscribed to a data stream. The assigning of a maximum quality (the clients can always subscribe to lower qualities depending on their local conditions) is carried out for the stream as a whole, in other words for a piece of content. This quality is established between the parties of the content streaming network and is not imposed by the network infrastructure.

Of course, the present development is not limited to the examples and to the embodiment described and represented, but is defined by the claims. It is, in particular, suitable for numerous variations accessible by a person skilled in the art.

1. A method for transmitting a set of data streams through a telecommunications network, the data streams being respectively transmitted to sets of clients, the method including the assignment of a maximum quality allocated to a data stream as a function of the number of clients in the set of clients to which the data stream is transmitted.

2. The method according to claim 1, wherein when the set of clients comprises at least two clients, the stream is transmitted in multicast mode, and when the set of clients only comprises a single client, the stream is transmitted in unicast mode.

3. The method according to claim 2, wherein the assignment of a maximum quality comprises, for a multicast stream, configuring a source of the data streams for transmitting the data best corresponding to the maximum quality allocated to the data streams.

4. The method according to claim 1, wherein the maximum quality is higher when the number of clients is higher.

5. The method according to claim 1, wherein the assignment of a maximum quality comprises, for a unicast stream, modifying the service plan for the data stream in order that it only includes qualities less than or equal to the maximum quality allocated to the data stream.

6. The method according to claim 1, wherein the maximum quality allocated to the data streams transmitted to the sets with the highest number of clients is not impacted.

7. The method according to claim 1, including an assignment of a new maximum quality allocated to a data stream after a delay greater than a determined time threshold.

8. A supervision device comprising a processor configured to assign a maximum quality allocated to a data stream, as a function of the number of clients in a set of clients to which the data stream is transmitted through the telecommunications network.

9. A system comprising a source of the data stream and a supervision device according to claim 8.

10. The system according to claim 9, wherein the source includes an interface intended to interoperate with the supervision device.

11. A computer program able to be implemented on a supervision device, the computer program comprising program code instructions which, when it is executed by a processor, performs the method defined in claim 1.

12. A non-transitory data storage medium on which at least one series of program code instructions for executing the method according to claim 1 is stored.
